(19) United States
(12) Patent Application Publication
(10) Pub. No.: US 2002/0152830 A1
(43) Pub. Date: Oct. 24, 2002

(54) Speed changing controller for controlling the derailleur of bicycle

(76) Inventor: Chen-Chun Chang, Taichung (TW)

Correspondence Address: BROWDY AND NEIMARK, P.L.L.C., 624 NINTH STREET, NW, SUITE 300, WASHINGTON, DC, 20001-5303, US

(21) Appl. No.: 09/954,296

(22) Filed: Sep. 18, 2001

(30) Foreign Application Priority Data
Apr. 20, 2001 (TW) 90206250

(51) Int. Cl. B62M 25/04; B62K 23/04

(52) U.S. Cl. 74/502.2

(57) ABSTRACT

A speed-changing controller adapted to connect the derailleur of a bicycle via a gear cable for controlling said derailleur, the controller comprises a fastening base, a driven member, a retaining member and a sleeve. The driven member and the sleeve are rotatably and respectively fitted on a shaft tube of said fastening base. The retaining member is fastened on said driven member and is provided with a protruding retaining portion which can be engaged with one of positioning portions of said fastening base at the time when said driven member is driven by said sleeve to rotate to a determined position so as to pull/loose the gear cable to control the derailleur for completing the speed-changing motion of the bicycle.

### FIELD OF THE INVENTION

The present invention relates generally to an accessory of a bicycle, and more particularly to a grip type speed-changing controller for controlling the derailleur of a bicycle.

### BACKGROUND OF THE INVENTION

The conventional grip type bicycle speed-changing controller uses a sleeve which is rotatably and collinearly fitted on the handle bar of the bicycle to pull/loose a gear cable which is connected to the derailleur of the bicycle at the time when the sleeve is rotated correspondingly to a fastening base which is collinearly fasten on the handle bar of the bicycle. The controller is further provided between the sleeve and the fastening base with a retaining member set to obtain the positioning effect when the sleeve is rotated to a predeterminate angle position so as to attain the speed-changing action. However, the conventional grip is usually complicated in construction or formed of many components. As shown in FIG. 1, the prior art grip type bicycle speed-changing controller comprises a sleeve 1, a fastening base 2, a cable-fastening member 3 disposed between the sleeve 1 and the base 2 for fastening an end of a gear cable (not shown in the FIG. 1), an arched positioning member 4, and an elastic retaining member 5. The cable-fastening member 3 is provided with an insertion slot 3a for receiving and fastening one end of the retaining member 5. The positioning member 4 is fitted into an annular slot 2a of the fastening base 2 so as to attaint the positioning effect. However, the prior art controller as shown in FIG. 1 includes many components, and these components are easy to touch one another to cause inconvenience when they are assembled.

### SUMMARY OF THE INVENTION

It is therefore the primary objective of the present invention to provide a bicycle speed-changing controller which has a simple structure and can be assembled with easy.

It is another objective of the present invention to provide a bicycle speed-changing controller which can be operated with precision and smooth.

In keeping with the principle of the present invention, the foregoing objectives of the present invention are attained by a speed-changing controller adapted to connect the derailleur of a bicycle via a gear cable for controlling said derailleur. The controller comprises a fastening base, a driven member, a retaining member and a sleeve. The fastening base is provided with a cable guiding portion, a basin-shaped housing having a bottom and an annular sidewall, a shaft tube protruding from a central portion of said bottom of said housing, and a receiving space which is defined between an inner surface of said annular sidewall and an outer surface of said shaft tube, said inner surface of said annular sidewall is provided with a plurality of positioning portions. The driven member with a disc-shaped body is provided with an axial hole, said axial hole being fitted on said shaft tube such that said driven member is pivoted on said shaft tube and located in said receiving space. The retaining member is fastened on said driven member and provided with a retaining portion which can be deformed along a radial direction of said shaft tube and being engaged with one of the positioning portions of said housing. The sleeve is rotatably fitted on said shaft tube such that the driven member is located between said fastening base and said sleeve and being driven by said sleeve to rotate, said sleeve is further provided with a cable fastening portion for fastening an end of said gear cable.

### BRIEF DESCRIPTION OF THE DRAWINGS

FIG. 1 shows an exploded view of a prior art grip type bicycle speed-changing controller.

FIG. 2 shows an exploded view of a first preferred embodiment of the present invention.

FIG. 3 is a sectional view of the preferred embodiment of the present invention which shows that the sleeve is at rest and the retaining member is located in one of the positioning portions of the housing.

FIG. 4 is a schematic view of the preferred embodiment of the present invention which shows that the sleeve is rotated at beginning.

FIG. 5 is a schematic view of the preferred embodiment of the present invention which shows that the sleeve actuate a driven member to rotate.

FIG. 6 is a schematic view of the preferred embodiment of the present invention which shows that the retaining member is located in another positioning portion of the housing.

FIG. 7 is a schematic view of the preferred embodiment of the present invention which shows that the sleeve has completed the action.

FIG. 8 shows an exploded view of a second preferred embodiment of the present invention.

FIG. 9 is a sectional view of the second preferred embodiment of the present invention.

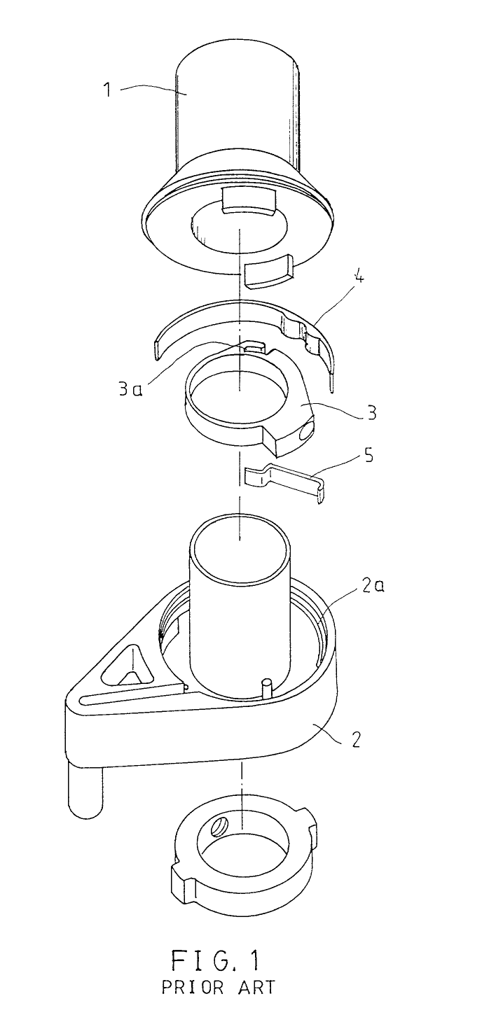

### DETAILED DESCRIPTION OF THE INVENTION

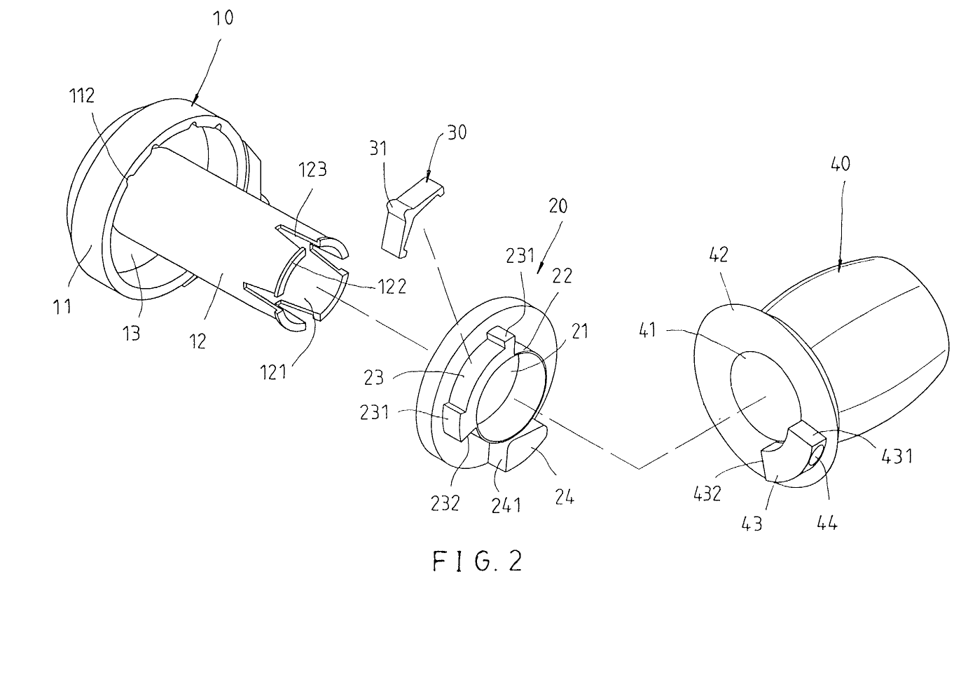

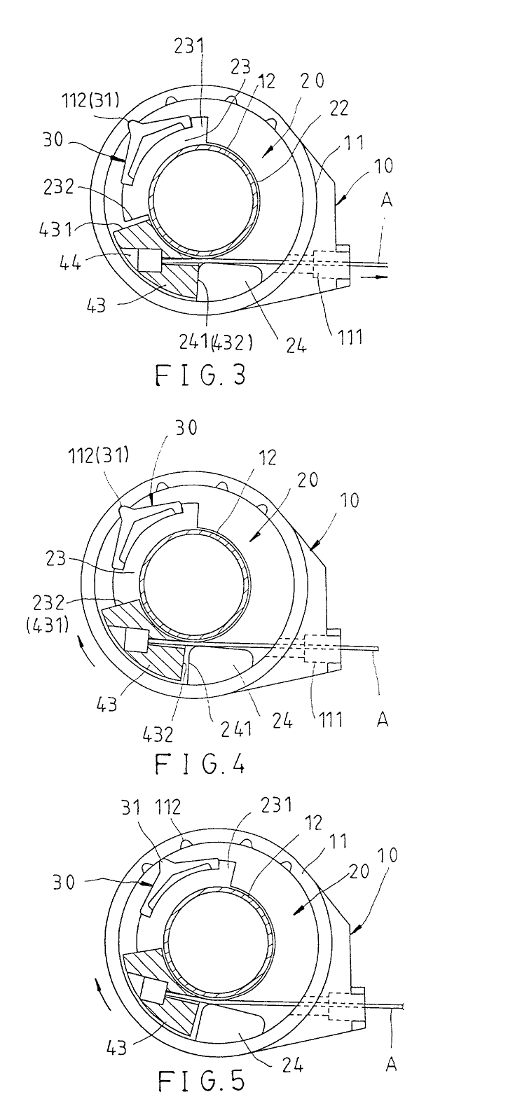

As shown in FIGS. 2 and 3, a speed-changing controller of the first preferred embodiment of the present invention is adapted to connect the derailleur (not shown in the FIGS.) of a bicycle via a gear cable A for controlling said derailleur. The controller comprises a fastening base 10, a driven member 20, a retaining member 30, and a sleeve 40.

The fastening base 10 is provided with a basin-shaped housing 11 having a bottom and an annular sidewall, a shaft tube 12 protruding from a central portion of the bottom of the housing 11, and a receiving space 13 which is confined between an inner surface of the annular sidewall of the housing 11 and an outer surface of the shaft tube 12. The housing 11 is provided in the annular sidewall thereof with a through hole to form a cable guiding portion 111 for guiding the gear cable A to pass trough the sidewall, and the inner surface of the annular sidewall of the housing 11 is provided with a plurality of recesses to form a plurality of positioning portions 112. The shaft tube 12 is provided in the interior thereof with an axial hole 121 passing through the bottom of the housing 11 such that the fastening base 10 can be fixed on the handle bar (not shown in the FIGS.) of the bicycle by means of the axial hole 121. The shaft tube 12 is further provided at a free end thereof with an annual flange 122, and a plurality of slots 123 extending from the free end of the shaft tube along the axial direction of the shaft tube so as to cause the free end of the shaft tube has an ability of deformation.

The driven member 20 have a disc-shaped body which is provided with an axial hole 21 being fitted on said shaft tube 12 such that the driven member 20 is pivoted on the shaft tube 12 and is located in the receiving space 13. The driven member 20 is further provided at a surface thereof along the periphery of the axial hole 21 with an annular wall 22, an arched bearing block 23, and a locating block 24. The bearing block 23 is provided at two ends thereof with a protrudent stopping block 231 respectively. A gap is confined between the annual sidewall 22 and the locating block 24 for allowing the gear cable A to pass trough. The corresponding surfaces of the bearing block 23 and the locating block 24 are formed of a first stopping surface 232 and a second stopping surface 241 respectively.

The retaining member 30 has a sheetlike body with the performance of deformation and is disposed between the two stopping blocks 231 of the bearing block 23. The retaining member 30 has a bulging midsection and a bulge protruding outward from the outer surface of the midsection to form a retaining portion 31. Two ends of the retaining member are extended downwardly and being contacted with the two stopping blocks 231 respectively such that said retaining portion 31 of said retaining member 30 can be deformed along a radial direction of the shaft tube 12 at the time when said retaining member 30 is forced by an external force.

The sleeve 40 is provided with an axial hole 41 and is rotatably fitted on the shaft tube 12 with the flange 122 of said shaft tube 12 is stopped at an end surface of said sleeve 40 so as to preventing the sleeve 40 to be pulled out from the shaft tube. The sleeve 40 is provided at the other end thereof with a base surface 42 and a pushing block 43 protruding from the base surface 42. The pushing block 43 is further provided with a first pushing surface 431, a second pushing surface 432, and a stepped through hole to form a cable fastening portion 44 for fastening one end of the gear cable A. In practice, the pushing block 43 is disposed between the first stopping surface 232 and the second stopping surface 241. When the sleeve 40 is at rest, the first pushing surface 431 is spaced in an interval with the first stopping surface 232, and the second pushing surface 432 is contacted with the second stopping surface 241, as shown in FIG. 3.

Please refer to FIG. 3, which shows that the sleeve 40 is at rest. At this stage, the retaining portion 31 of the retaining member 30 is engaged with one of the positioning portions 112 of the fastening base 10, and the gear cable A is pulled by an elastic external force provided by the derailleur so as to force the second pushing surface 432 of the pushing block 43 to be touched with the second stopping surface 241, and the first pushing surface 431 is spaced in an interval with the first stopping surface 232. When the sleeve 40 is actuated to rotate clockwise by an external force provided by the user, the pushing block 43 is first traveling a distance equal to the interval described above, and then the first pushing surface 431 is contacted with the first stopping surface 232, as shown in FIG. 4. Thereafter, the sleeve 40 is continuing in rotation such that the pushing block 43 will drive the driven member 20 along with the retaining member 30 to move together. In the meantime, the retaining portion 31 of the retaining member 30 is forced against the inner surface of the annular sidewall of the housing 11 so as to cause an inward deformation of the retaining member 30, as shown in FIG. 5, such that the driven member 20 can be rotated readily.

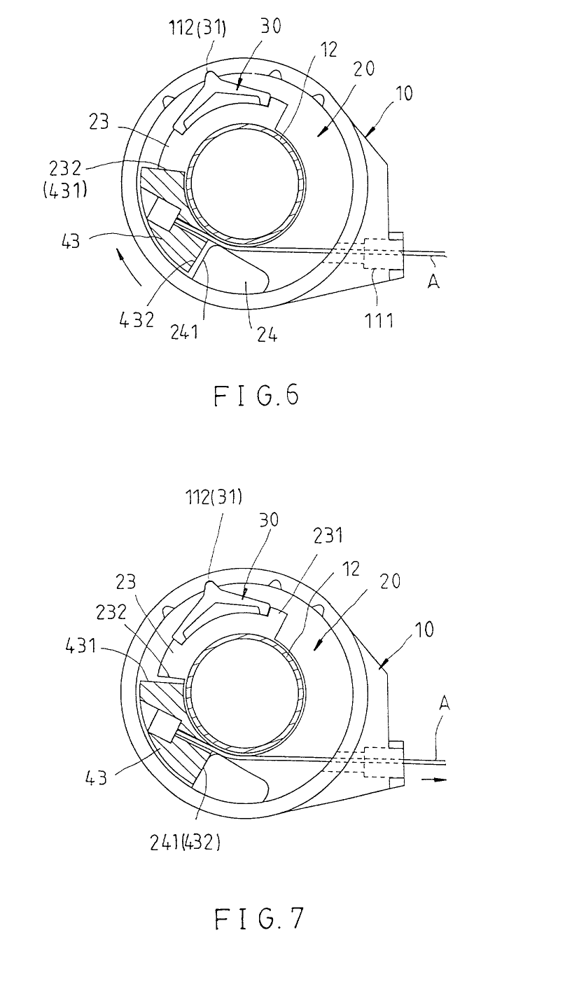

And then, the sleeve 40 is continuing in rotation until the retaining portion 31 of the retaining member 30 is engaged with the next positioning portion 112, as shown in FIG. 6, so as to complete the gear-changing action of the derailleur. Please further refer to FIG. 7, as soon as the user has completed the gear-changing action, the user release the external force forced on the sleeve 40, then the pushing block 43 will be moved counterclockwise due to the pulled force provided by the derailleur via the gear cable until the second pushing surface 432 contact the second stopping surface 241 again.

In light of the above, the controller of the present invention is simple and easy in fabrication and assembling. Furthermore, as shown in FIGS. 3-6, the pushing block 43 is first traveling a distance equal to the interval confined between the first pushing surface 431 and the first stopping surface 232, then the pushing block 43 is driving the driven 20 to move until completing the gear-changing action. Such an action can provide a suitable overshifting effect at the time when the chain of the bicycle is to be moved from a chainwheel to the adjacent chainwheel, so as to cause the gear-changing action more smoothly and exactly.

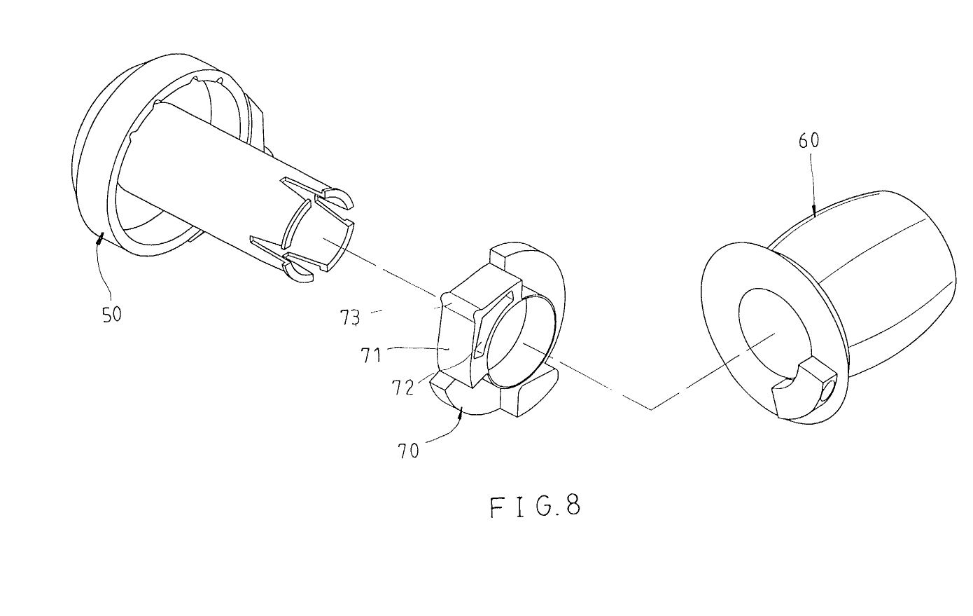

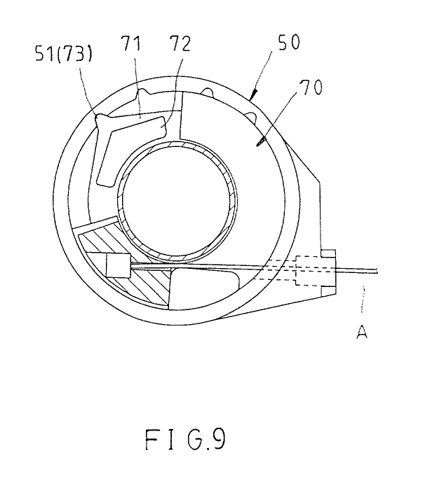

Please refer to FIGS. 8 and 9, a speed-changing controller of the second preferred embodiment of the present invention is shown. The fastening base 50 and the sleeve 60 of this embodiment of the present invention are exactly the same as they are disclosed in the first embodiment of the present invention. However, as shown in the FIGS. 8 and 9, the driven member and the retaining member are made integrally. In brief, the driven member 70 of the second embodiment of the present invention is provided at the periphery thereof with a flexible sheet 71 and a hollow 72 disposed between the flexible sheet 71 and the central portion of the driven member. The flexible sheet 71 has a bulging midsection and a bulge protruding outward from the outer surface of the midsection to form a retaining portion 73. As shown in FIG. 9, the retaining portion 73 is engaged with one of the positioning portions 51 of the fastening base 50. The actions of how to operate the controller are exactly the same as they are described above. However, the assembling and the fabrication of the second embodiment are simpler than that of the first embodiment of the present invention.

What is claimed is:

1. A speed-changing controller adapted to connect the derailleur of a bicycle via a gear cable for controlling said derailleur, said controller comprising:
a fastening base provided with a cable guiding portion, a basin-shaped housing having a bottom and an annular sidewall, a shaft tube protruding from a central portion of said bottom of said housing, and a receiving space which is defined between an inner surface of said annular sidewall and an outer surface of said shaft tube, said inner surface of said annular sidewall is provided with a plurality of positioning portions;
a driven member with a disc-shaped body provided with an axial hole, said axial hole being fitted on said shaft tube such that said driven member is pivoted on said shaft tube and located in said receiving space;
a retaining member fastened on said driven member and provided with a retaining portion which can be deformed along a radial direction of said shaft tube and being engaged with one of the positioning portions of said housing;
a sleeve rotatably fitted on said shaft tube such that the driven member is located between said fastening base and said sleeve and being driven by said sleeve to rotate, said sleeve is further provided with a cable fastening portion for fastening an end of said gear cable.

2. The controller as defined in claim 1, wherein said driven member is provided with a first stopping surface and a second stopping surface protruding from a surface of said driven member respectively, said sleeve is provided at an end thereof with a base surface and a pushing block protruding from the base surface of said sleeve and is deposed between said first stopping surface and said second stopping surface, said pushing block is provided with a first pushing surface spaced said first stopping surface in an interval and a second pushing surface contacted said second stopping surface at the time when said sleeve is at rest, and said first pushing surface being contacted said first stopping surface to push said driven member to rotate at the time when said sleeve is rotated.

3. The controller as defined in claim 2, wherein said pushing block of said sleeve is further provided with a through hole to form said cable fastening portion of said sleeve.

4. The controller as defined in claim 1, wherein said driven member is provided at a surface thereof with a protrudent bearing block, said bearing block is provided at two ends thereof with a stopping block respectively, said retaining member having a sheetlike body with a bulging midsection, a bulge protruding outward from an outer surface of said midsection to form said retaining portion, and two ends contacted said stopping blocks respectively such that said retaining portion of said retaining member can be deformed in a radial direction of said shaft tube at the time when said retaining member is forced by an external force.

5. The controller as defined in claim 4, wherein said inner surface of said annular sidewall of said housing is provided with a plurality of recesses to form said positioning portions for receiving said bulge of said retaining member.

6. The controller as defined in claim 1, wherein the shaft tube of said fastening base is provided in the interior thereof with an axial hole passing through the bottom of said housing;
a free end of said shaft tube is provided an annular flange;
a plurality of slots extending from said free end of said shaft tube along an axial direction of said shaft tube;
said flange of said shaft tube is stopped with an end of said sleeve when said sleeve is fitted on the shaft tube.

7. A speed-changing controller adapted to connect the derailleur of a bicycle via a gear cable for controlling said derailleur, said controller comprising:
a fastening base provided with a cable guiding portion, a basin-shaped housing having a bottom and an annular sidewall, a shaft tube protruding from a central portion of said bottom of said housing; and a receiving space is defined between an inner surface of said annular sidewall and an outer surface of said shaft tube, said inner surface of said annular sidewall is provided with a plurality of positioning portions;
a driven member with a disc-shaped body provided with an axial hole being fitted on said shaft tube such that said driven member is pivoted on said shaft tube and located in said receiving space and a retaining portion which can be deformed in a radial direction of said shaft tube and being engaged with one of the positioning portions of said housing;
a sleeve rotatably fitted on said shaft tube such that the driven member is located between said fastening base and said sleeve and being driven by said sleeve to rotate, said sleeve is further provided with a cable fastening portion for fastening an end of said gear cable.

8. The controller as defined in claim 7, wherein said driven member is integrally provided at the periphery thereof with a flexible sheet and a hollow disposed between said flexible sheet and the central portion of said driven member, said flexible sheet having a bulging midsection and a bulge protruding outward from an outer surface of said midsection to form said retaining portion.
